(19) United States
(12) Patent Application Publication
(10) Pub. No.: US 2004/0120599 A1
(43) Pub. Date: Jun. 24, 2004

(54) Detection and enhancement of backlit images

(75) Inventor: Sharon Alison Henley, Mountain View, CA (US)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Ohta-ku (JP)

(21) Appl. No.: 10/322,699

(22) Filed: Dec. 19, 2002

(51) Int. Cl. G06K 9/40; G06K 9/00

(52) U.S. Cl. 382/274; 382/168

(57) ABSTRACT

The present invention detects backlit images by analysis of the shape of its luminance histogram, and enhances backlit and low contrast images by application of a mask in the frequency, rather than spatial domain. More particularly, the present invention detects backlit images by analysis of a luminance histogram to determine if the histogram is inverse-bell-shaped or double-peaked, by smoothing the histogram, converting the smoothed histogram into a curve function, counting the number of crossings of the curve function at a baseline, and designating the image as backlit if the number of crossings is four or more. The invention preferably adjusts the image's luminance histogram vertically, along the Y-axis, and counts crossings at the X-axis. Additionally, the invention enhances backlit and low contrast images by converting luminance information from the spatial domain to the frequency domain, applying a mask that reduces global contrast and accentuates local contrast, inverting the masked luminance information to obtain manipulated luminance information in the spatial domain, and replacing the original luminance channel with the manipulated luminance information. The invention preferably takes the logarithm of the luminance information calculated in the frequency domain, and takes the inverse logarithm of the inverted, masked luminance information.

### BACKGROUND OF THE INVENTION

1. Field of the Invention

This invention relates to the field of automatic image enhancement. More particularly, the present invention relates to the detection and enhancement of digital image data for backlit and other low contrast images.

2. Description of the Related Art

Most consumer cameras have features such as auto exposure and over-exposure which allow operators to take high quality pictures under varied lighting conditions. According to research conducted by the inventor herein, however, backlit photographs still account for the largest proportion of poor quality images taken by consumer cameras, and are produced when the main illumination comes from behind the primary subject of the image.

Although backlit images and other images of low contrast are often quite easy to spot visually, automatic detection is more difficult. Most typical detection techniques analyze an image's overall color saturation levels. These methods are inadequate because backlighting results from an imbalance of light and dark, not color. Other techniques look in an image's luminance histogram for a shape indicative of backlighting. These luminance techniques are insufficient because the shapes they look for do not include many of the shapes which are indicative of backlit images. As such, existing detection techniques are often deficient and fail to properly detect many images which are backlit.

Enhancement of backlit images is even more difficult than detection. Typical methods include gamma correction, white balancing, normalization and sharpening. However, these methods enhance the image globally, without recognizing the important contributions of local variation in contrast. Moreover, common enhancement techniques often discolor or brighten the enhanced image unnaturally.

### SUMMARY OF THE INVENTION

It is an object of the invention to address disadvantages found in prior art detection and enhancement of backlit and other low contrast images.

In one aspect of the present invention, backlighting is detected by analysis of an image's luminance histogram to determine if the histogram is inverse-bell-shaped or double-peaked.

In more detail, the image's luminance histogram is smoothed and converted into a curve function, a count is made of the number of crossings at a baseline, and the image is designated as backlit if the number of crossings is four or more. This allows the invention to detect both of two different shapes in the histogram, double-peak and inverse-bell shapes, both of which are indicative of a backlit image.

In a further, preferred embodiment of the detection portion of the invention, the image's luminance histogram is shifted vertically along the Y-axis to remove baseline noise, and a count is made of crossings at the X-axis. Using this method, “noise” is reduced from the low luminance range of the histogram, easing calculations by counting the crossings at the X-axis.

In another aspect of the invention, a backlit image or an image with low contrast is enhanced through calculations performed in the frequency domain. The image's luminance information is converted into the frequency domain, a mask is applied with the mask being tailored to reduce global contrast and accentuate local contrast, the masked luminance information is inverted to obtain manipulated luminance information in the spatial domain, and the original luminance channel is replaced with the manipulated luminance information.

By making appropriate enhancements in the frequency domain, enhancement according to the invention tends to preserve the image's natural color saturation characteristics, and is able to reduce global contrast while increasing local contrast. As a result, enhancements are applied more evenly across the entire color spectrum, and individual color levels remain relatively free of distortion or discoloration.

In a preferred embodiment of the enhancement portion of the invention, RGB color information of the image is converted to HSV coordinates, and the V-channel information is normalized in the frequency domain to encompass the range 0 to 255. In an additional preferred embodiment of the enhancement portion of the invention, the logarithm of the luminance information is calculated in the spatial domain prior to the conversion to the frequency domain, and the inverse logarithm is calculated of the inverted, masked luminance information. Image enhancement which both normalizes the luminance information in the frequency domain and takes the logarithm of the luminance information produces a more visually representative enhanced image, by uncompressing the shadow areas in subsequent calculations.

In a further preferred embodiment of the invention, the mask which is applied to the luminance information in the frequency domain is generated as follows, where F(x,y) represents the mask:

F(x,y)=(1−1/N)*H(x,y)+1/N,

where N is the enhancement value of the filter, discussed herein, and H(x,y) is given as follows:

H(x,y)=1−(1/(1+[D₀/D(x,y)]²))

where D₀ is the cutoff frequency at a distance D₀ from the origin, discussed herein, and D(x,y) is given as follows:

D(x,y)=[(x−L/2)²+(y−W/2)²]^{1/2}

where L*W is the size of the original V channel.

D₀ and N are both parameters to the mask, and can be adjusted to affect mask properties. Recommended values are D₀=0.25 and N=2.5. Increasing D₀ and N generally lightens an image, so enhancement and cutoff values must be larger darker images, and smaller for lighter images. The value for N can alternatively be estimated using the amount of space between major peaks in the luminance histogram. For a luminance histogram with a narrow space (a double-peak shaped), a larger N is required. For a luminance histogram with a wide gap between peaks (a inverse-bell shape), a smaller N is required. D₀ is the maximum attenuation threshold for values represented in the FFT.

This brief summary has been provided so that the nature of the invention may be understood quickly. A more complete understanding of the invention can be obtained by reference to the following detailed description of the preferred embodiments thereof in connection with the attached drawings.

### DESCRIPTION OF THE DRAWINGS

FIG. 1 depicts an example of a computing environment in which the invention may be employed.

FIG. 2 depicts an example of an internal architecture of a computer workstation in which the invention may be employed.

FIG. 3 is a flow chart depicting the detection and enhancement process.

FIG. 4 is a flow chart depicting the detection process according to one embodiment of the invention.

FIGS. 5(a) to 5(g) depict example images and graphs associated with the backlighting detection process.

FIG. 6 is a flow chart depicting the enhancement process according to the preferred embodiment of the invention.

FIGS. 7(a) to 7(c) depict an example of multiplying an FFT of an image by a mask.

FIGS. 8(a) to 8(h) depict the enhancement of an example image using a constant enhancement value and a range of cutoff values.

FIGS. 9(a) to 9(h) depict the enhancement of an example image using a range of enhancement values and a constant cutoff value.

FIG. 10 is a flow chart depicting the enhancement process according to an additional embodiment of the invention.

FIGS. 11(a) to 11(d) depict example images prior and subsequent to enhancement.

### DETAILED DESCRIPTION OF THE PREFERRED EMBODIMENTS

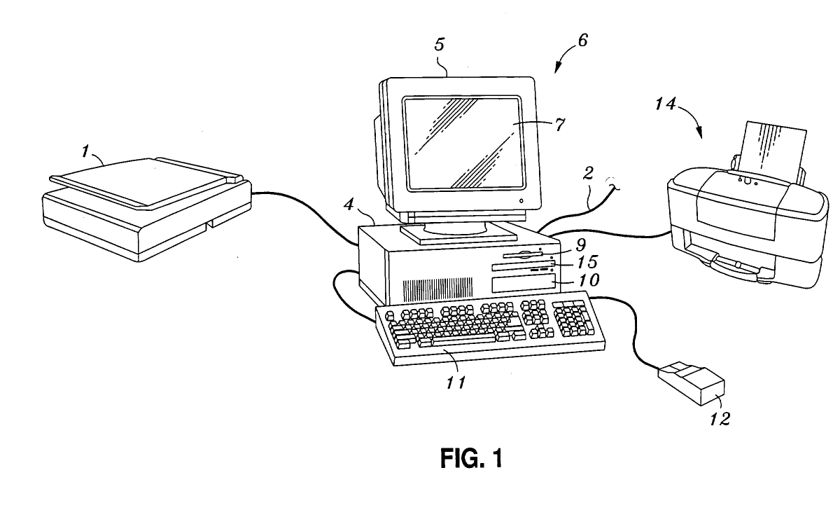

FIG. 1 is a view showing the outward appearance of representative computing equipment 6 which includes computer-readable storage medium for the detection and enhancement of digital image data for backlit and low contrast images. Computing equipment 6 includes host processor 4 which comprises a personal computer (hereinafter “PC”) preferably having a windowing operating system such as Microsoft Windows, Xwindows, or MacIntosh operating systems. Provided with computing equipment 6 are color monitor 5 including display screen 7, keyboard 11 for entering text data and user commands, and pointing device 12. Pointing device 12 preferably comprises a mouse, for pointing, selecting and manipulating objects displayed on display screen 7.

Computing equipment 6 includes a computer readable memory medium such as a fixed disk 10 and/or floppy disk drive 9 and or CDROM drive 15. Such computer readable memory media allow computing equipment 6 to access information such as image data, computer-executable process steps, application programs, and the like, stored on removable and non-removable memory media. In addition, network access 2 allows computing equipment 6 to acquire information, images and application programs from other sources, such as a local area network or the internet. Digital input device 1 allows computing equipment 6 to capture digital images, and is preferably a digital camera, digital video camera or scanner.

Printer 14 is a color output device such as an ink jet printer or a color laser beam printer.

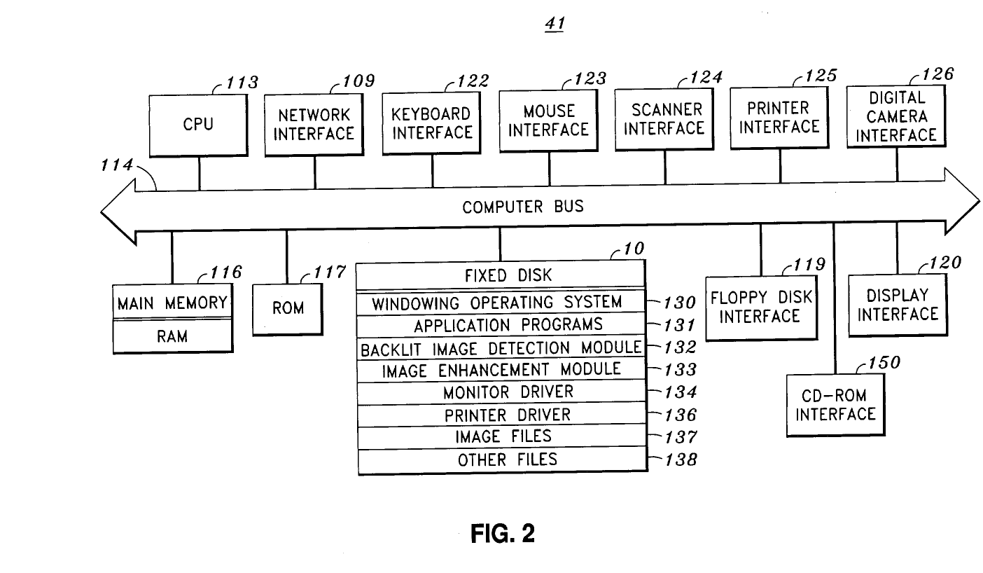

FIG. 2 is a detailed block diagram showing the internal architecture of PC 4. As shown in FIG. 2, PC 4 includes a central processing unit (“CPU”) 113 that interfaces with computer bus 114. Also interfacing with computer bus 114 are fixed disk 10, network interface 109 for network access 2, random access memory (“RAM”) 116 for use as main memory, read only memory (“ROM”) 117, floppy disk interface 119, CDROM interface 150 to CDROM 15, display interface 120 to monitor 5, keyboard interface 122 to keyboard 11, mouse interface 123 to pointing device 12, scanner interface 124, digital camera interface 126 to digital input device 1, and printer interface 125 to printer 14.

Main memory 116 interfaces with computer bus 114 so as to provide RAM storage to CPU 113 during execution of software programs such as the operating system, application programs, and device drivers. More specifically, CPU 113 loads computer-executable process steps from fixed disk 9 or other memory media into a region of main memory 116, and thereafter executes the stored process steps from main memory 116 in order to execute software programs. Data such as color images can be stored in main memory 116, where the data can be accessed by CPU 113 during execution.

As also shown in FIG. 2, fixed disk 10 contains a window operating system 130, application programs 131 such as application programs that manipulate, obtain and print color images, a backlit image detection module 132, an image enhancement module 133, and image files 137. Automatic detection and enhancement of digital image data for backlit and low contrast images according to the invention is preferably implemented according a backlit image detection module 132 and an image enhancement module 133 as shown. It is possible to implement a backlit image detection module or an image enhancement module according to the invention as a dynamic link library (“DLL”), or as a plug-in to other application programs such as image manipulation programs like Adobe Photoshop.

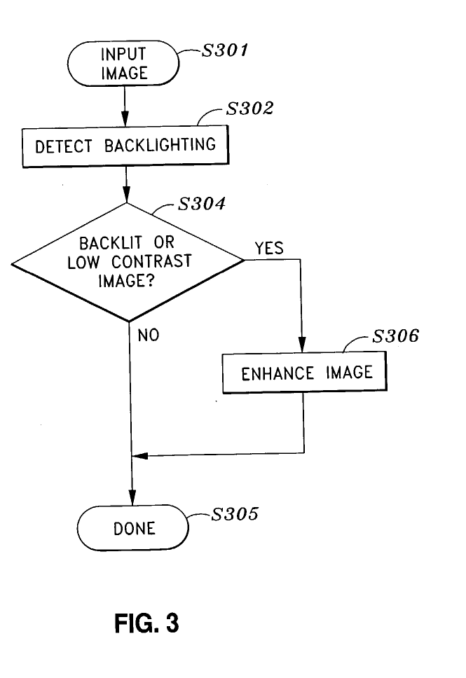

FIG. 3 is a flow chart depicting the detection and enhancement processes. As seen in FIG. 1, with regards to backlight detection, an image is input (step S301), backlighting is detected (step S302), and it is determined whether the image has backlighting or low contrast (step S304). If the image is not backlit or is not low contrast, the process ends, and the original image is output (step S305). Alternatively, enhancement is performed on backlit or low contrast images (step S306), and the enhanced image is output (step S305).

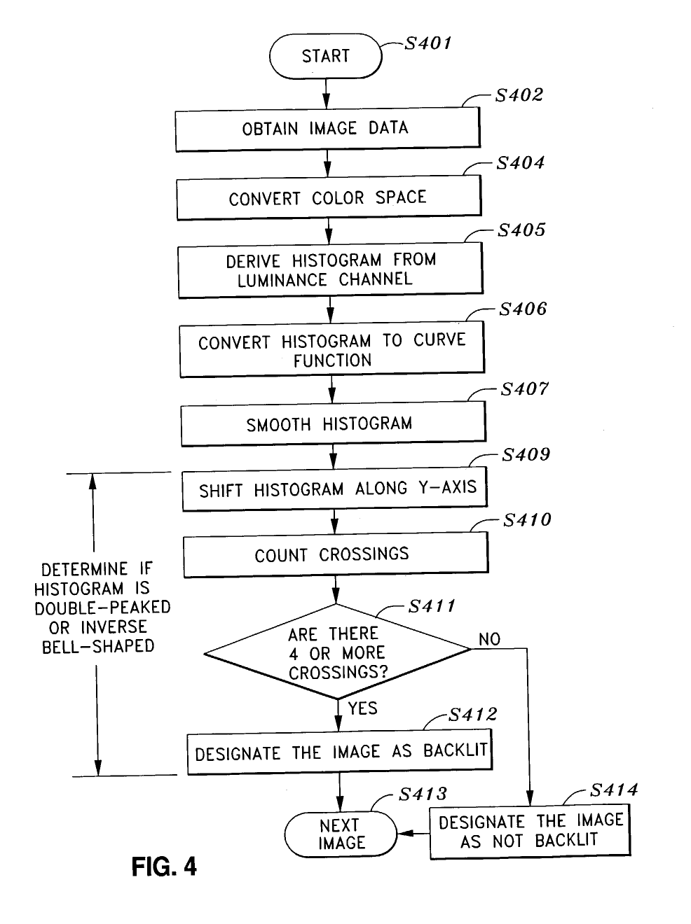

FIG. 4 is a flow chart depicting the detection process according to step S302. Briefly, according to this embodiment, backlit images are detected by analysis of a luminance histogram to determine if the histogram is inverse-bell shaped or double peaked, by smoothing the image's luminance histogram, converting the smoothed histogram into a curve function, shifting the histogram vertically along the Y-axis, counting the number of crossings of the curve function at a baseline, and designating the image as backlit if the number of crossings is four or more.

In more detail, image data is obtained through a digital image capturing device, such as a scanner or digital camera, or from a file on disk (step S402), then converted into a color space having a luminance channel (step S404). Examples of color spaces which include luminance channels include, but are not limited to, L*a*b, HSL, or HSV, and any of these color spaces may effectively be used in this invention.

Once the image data has been input and is converted, the resulting luminance channel data must be expressed in a manner capable of being analyzed automatically. In the present invention, a histogram of the luminance channel is generated (step S405), and the resulting histogram is turned into a curve function (step S406). The invention uses this curve function to determine if the histogram is inverse-bell shaped or double peaked. Next, the curve is smoothed, such as by low-pass filtering, as to remove local “noise” (step S407). Smoothing helps eliminate minor spikes and local roughness on the curve function, allowing enhanced detection of backlighting indicia.

Following smoothing, a determination is made of whether an image is backlit by judging whether the histogram is double-peak shaped or inverse-bell shaped (steps S409 to S414). In more detail, the curve function is preferably shifted vertically down along the Y-axis (step S409). Although the shifting step is optional, adjusting the curve down the Y-axis allows for more convenient and less computationally expensive counting of crossings, as described herein. Next, a count is made of the number of crossings the resulting curve makes at a baseline (step S410). If the curve has been shifted vertically, as described in optional step S409, the baseline should be the X-axis. If the curve has not been shifted vertically, a count is made a baseline which is not necessarily the X-axis.

The shape of the luminance histogram is determined using the count performed in step S410 (step S411). If the curve crosses the X-axis more then four times, the image has a double-peak or inverse-bell shape, and is designated as backlit (step S412). If the curve crosses the baseline less than four times, the image is designated as not backlit (step S414). After the counting and backlight determination, the process awaits the input of the next image (step S413), or proceeds to the enhancement portion of the invention (step S306)

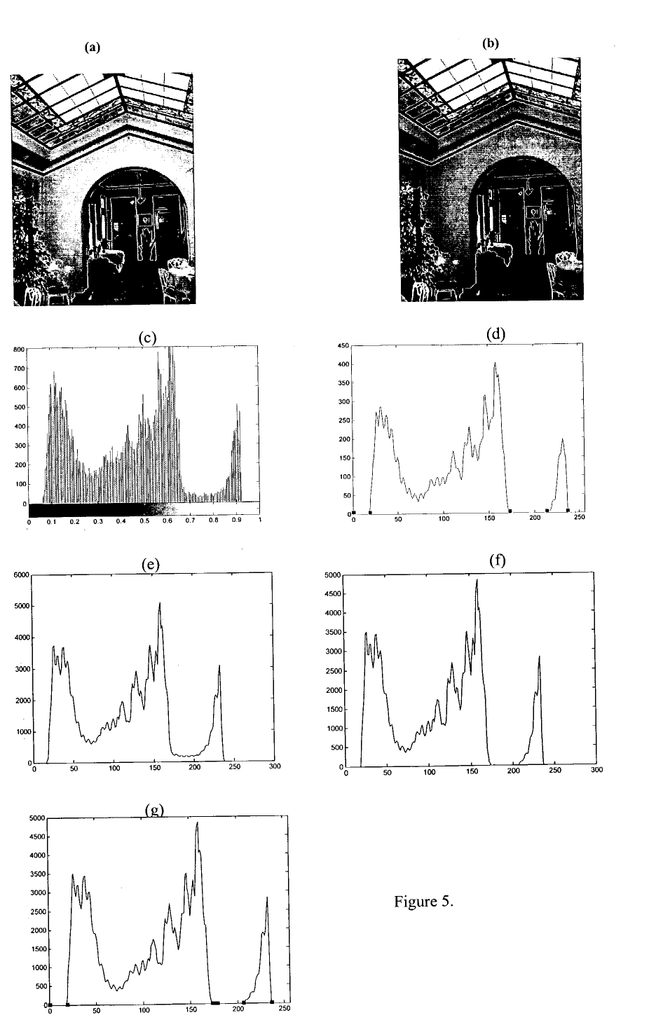

FIGS. 5(a) to (g) depict images and graphs which exemplify each step of the backlighting detection process. FIG. 5(a) depicts step S402, where a sample backlit image which is read into a computer using an image capturing device such as a scanner or digital camera, or from a file on disk. FIG. 5(b) depicts step S404, where the same backlit image is converted into HSV color space. FIG. 5(c) depicts step S405, where the luminance histogram is generated from the original sample image. FIG. 5(d) depicts step S406, particularly the creation of the curve function from the luminance histogram of the original sample image. FIG. 5(e) depicts step S407, showing the smoothed the curve function created from the luminance histogram of the original sample image. FIG. 5(f) depicts optional step S409, where the curve function created from the luminance histogram of the original sample image is shifted downward along the Y-axis. FIG. 5(g) depicts step S410, where the crossings are counted at a baseline, which in this case is the X-axis. According to the process depicted in steps S411 and S412 of FIG. 4, this particular example image would be designated as backlit since there are four crossings, and therefore could be subsequently enhanced in accordance with step S306.

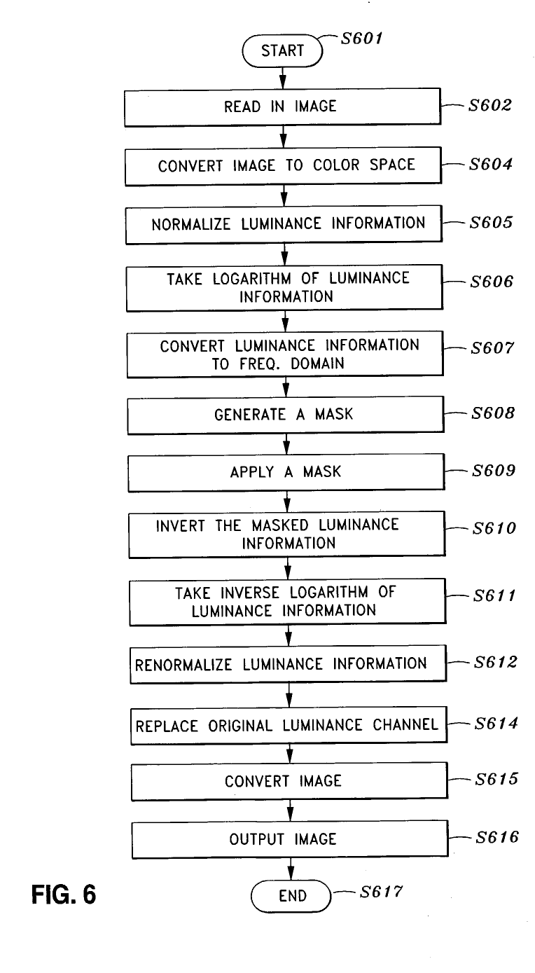

FIG. 6 is a flow chart depicting the enhancement process of step S306. Briefly, according to this embodiment, low contrast and backlit images that include luminance information and chroma information in a spatial domain are enhanced by converting the luminance information from the spatial domain to the frequency domain, applying a mask that reduces global contrast and accentuates local contrast where the mask has parameters which can be adjusted to affect mask properties, inverting the masked luminance information to obtain manipulated luminance information in the spatial domain, and replacing the original luminance channel with the manipulated luminance information.

In more detail, image data is obtained through a digital image capturing device, such as a scanner or digital camera, or from a file on a disk (step S602), then converted into a color space having a luminance channel (step S604). Examples of color spaces which include luminance channels include, but are not limited to L*a*b, HSL, or HSV, and any of these color spaces may effectively be used in this invention. The luminance channel is preferably normalized to encompass a range of 0 to 255 (step S606). Although this step is optional, normalizing makes the luminance values encompass the entire channel, maximizing the effect of the final enhancement.

Following normalization, it is preferable to perform calculations to make the luminance channel more visually representative. In the present invention, the logarithm is taken of the luminance channel (step S606). Although this step is also not required, taking the logarithm of the luminance channel tends to pull details out of the shadows of a low contrast image because the logarithm of the luminance channel is more visually representative than the natural luminance channel values. This technique of compressing shadows, known as using “log density,” is a common technique in printing. If the logarithm of the luminance channel is taken, it is also necessary to take the inverse logarithm later, in step S611, detailed below.

Next, the luminance information is converted from the spatial to the frequency domain (step S607). By making appropriate enhancements in the frequency domain, enhancement according to the invention tends to preserve the image's natural color saturation characteristics, and is able to reduce global contrast while increasing local contrast. As a result, enhancements are applied more evenly across the entire color spectrum, and individual color levels remain relatively free of distortion or discoloration. As example of one available technique, a Fast Fourier Transform (FFT) can be performed on the luminance channel to converting luminance information from the spatial domain to the frequency domain. Placing the image in the frequency domain puts the high contrast portion within the center of the image, and allows the invention to expeditiously reduce global contrast while increasing local contrast, instead of making pixel-by-pixel correction

A mask is then generated to reduce global contrast and accentuate local contrast (step S608). The mask, represented by F(x,y) in the equation below, is generated based on the original image data through the following equations:

F(x,y)=(1−1/N)*H(x,y)+1/N,

where N is the enhancement value of the filter, discussed below, and H(x,y) is given as follows:

H(x,y)=1−(1/(1+[D₀/D(x,y)]²))

where D₀ is the cutoff frequency at a distance D₀ from the origin, discussed herein, and D(x,y) is given as follows:

D(x,y)=[(x−L/2)²+(y−W/2)²]^{1/2}

where L*W is the size of the original V channel.

D₀ and N are both parameters to the mask, and can be adjusted to affect mask properties. Recommended values are D₀=0.25 and N=2.5. Increasing D₀ and N generally lightens an image, so enhancement and cutoff values must be larger for darker images, and smaller for lighter images. The value for N can alternatively be estimated using the amount of space between major peaks in the luminance histogram. For a luminance histogram with a narrow space (a double-peak shape), a larger N is required. For a luminance histogram with a wide gap between peaks (a inverse-bell shape), a smaller N is required. D₀ is the maximum attenuation threshold for values represented in the FFT.

After the mask, F(x,y), is generated, it is multiplied with the original luminance information in the frequency domain (step S609), then the masked luminance information is inverted to obtain convoluted luminance information in the spatial domain (step S610).

If the logarithm of the luminance information was taken in step S606, the inverse logarithm is taken of the manipulated luminance information (step S611). If optional step S606 was not performed, the inverse logarithm is not taken in step S611.

The spatial domain luminance information is then preferably normalized to encompass a range of 0 to 255 (step S612). Although this step is optional, normalizing makes the luminance values encompass the entire channel, maximizing the effect of the enhancement. This spatial domain luminance information replaces the original luminance channel of the image (step S614), and the image is converted from the color space used above, to the original image color space (step S615). The enhanced image is then output (step S616).

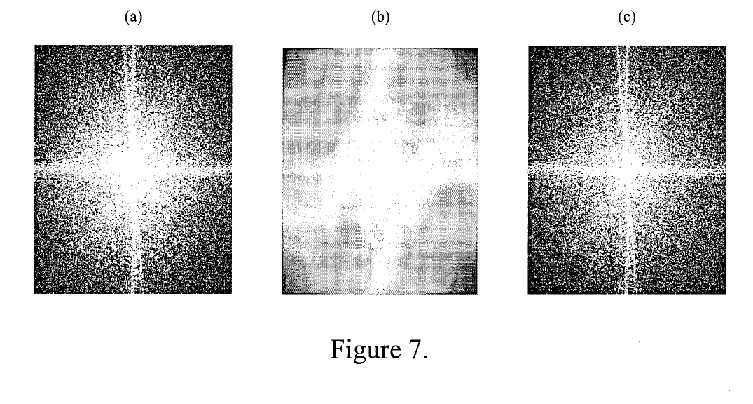

FIGS. 7(a) to (c) depict an example of multiplying an FFT of an image by a mask, as described above (step S609). FIG. 7(a) depicts a sample FFT of an image, while FIG. 7(b) depicts a sample mask. FIG. 7(c) depicts the resultant FFT*Filter after combining the sample FFT and mask. The goal of this combination, as indicated above, is to create a mask which minimizes global image contrast while accentuating local image contrast.

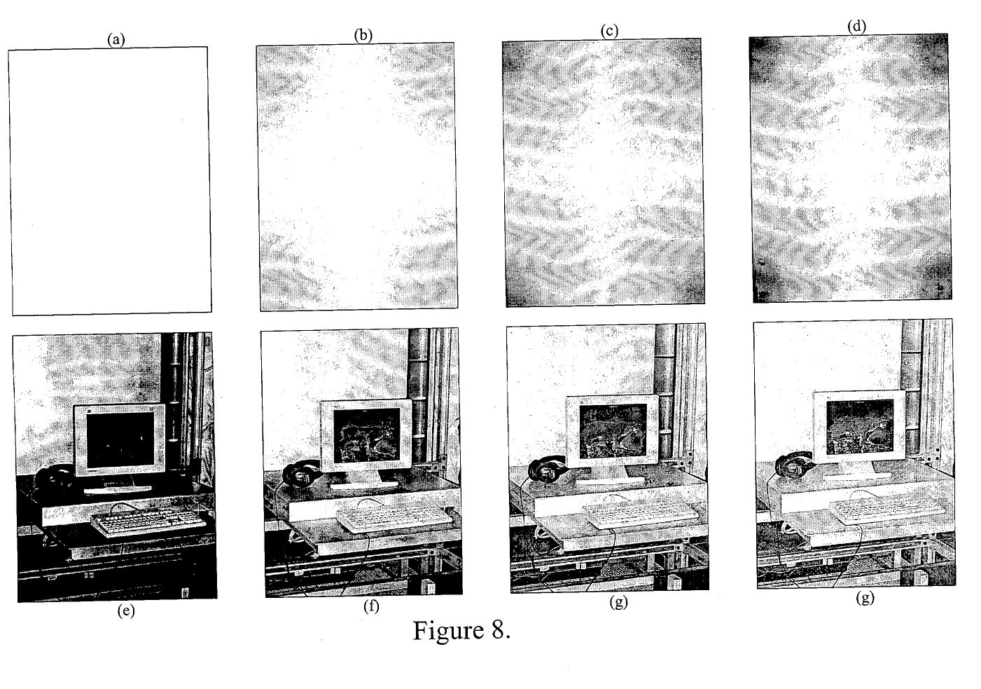

FIGS. 8(a) to 8(h) depict the enhancement of an example image using a constant enhancement value and a range of cutoff values. The efficacy of the mask is dependent upon the user's selection of proper enhancement (N) and cutoff frequency (D₀) values when generating the mask, as described above (step S609). FIGS. 8(a) to 8(d) depict the FFT mask with a constant enhancement value of N =2.5, and a cutoff frequency value of D₀=0.05, 0.1, 0.25 and 0.5, respectively. FIGS. 8(e) to 8(h) depict a sample image, enhanced with the FFT masks depicted in FIGS. 8(a) to 8(d), respectively. Increasing the cutoff frequency value, D₀, tends to lighten an image, while decreasing D₀ tends to darken an enhanced image.

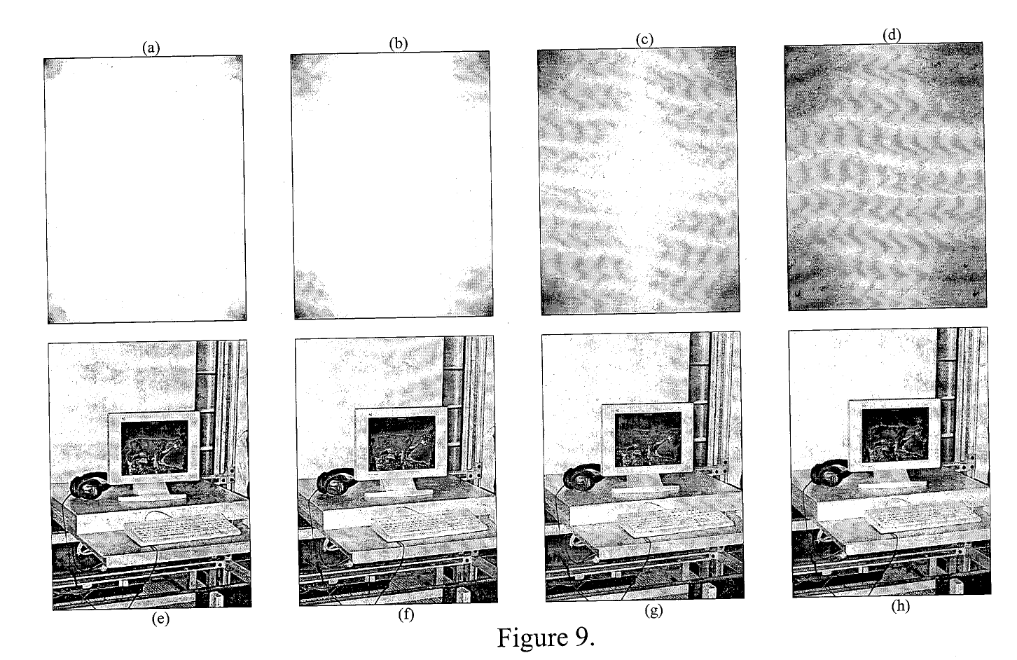

FIGS. 9(a) to 9(h) depict the enhancement of an example image using a range of enhancement values and a constant cutoff value. The efficacy of the mask is dependent upon the user's selection of proper enhancement (N) and cutoff frequency (D₀) values when generating the mask, as described above (step S609). FIGS. 9(a) to 9(d) depict the FFT mask with a constant cutoff frequency value of D₀=0.25, and enhancement values of N=0, 1.5, 2.5 and 3.5, respectively. FIGS. 9(e) to 9(h) depict a sample image, enhanced with the FFT masks depicted in FIGS. 9(a) to 9(d), respectively. Increasing the enhancement value, N, tends to lighten an image, while decreasing N tends to darken an enhanced image.

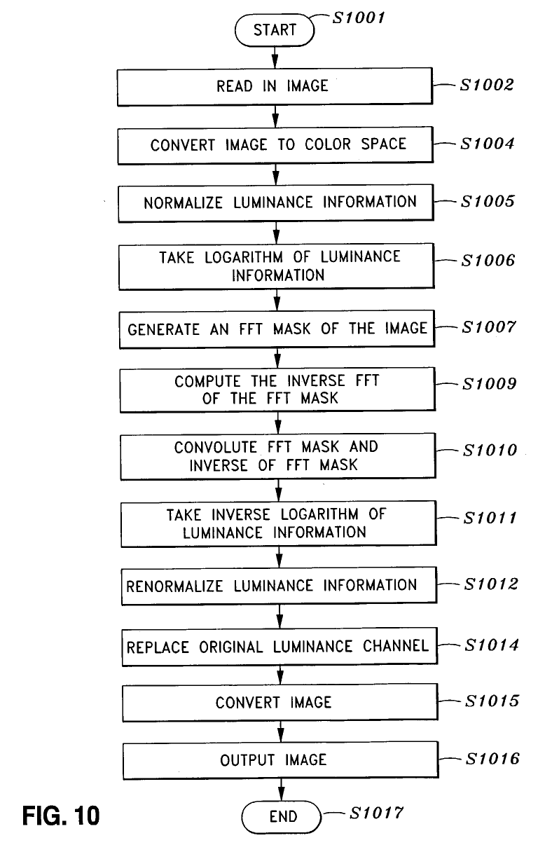

FIG. 10 is a flow chart depicting an alternative, spatial domain embodiment of the enhancement process of step S306. Briefly, according to this embodiment, low contrast and backlit images that include luminance information and chroma information in a spatial domain are enhanced by generating an FFT mask of the image which reduces global contrast and accentuates local contrast where the mask has parameters which can be adjusted to affect mask properties, computing the inverse FFT of the FFT mask, convoluting the FFT mask of the image with the inverse FFT of the FFT mask, and replacing the original luminance channel with the manipulated luminance information.

In more detail, image data is obtained through a digital image capturing device, such as a scanner or digital camera, or from a file on a disk (step S1002), then converted into a color space having a luminance channel (step S1004). Examples of color spaces which include luminance channels include, but are not limited to L*a*b, HSL, or HSV, and any of these color spaces may effectively be used in this invention. The luminance channel is preferably normalized to encompass a range of 0 to 255 (step S1006). Although this step is optional, normalizing makes the luminance values encompass the entire channel, maximizing the effect of the final enhancement.

Following normalization, it is preferable to perform calculations to make the luminance channel more visually representative. In the present invention, the logarithm is taken of the luminance channel (step S1006). Although this step is also not required, taking the logarithm of the luminance channel tends to pull details out of the shadows of a low contrast image because the logarithm of the luminance channel is more visually representative than the natural luminance channel values. This technique of compressing shadows, known as using “log density,” is a common technique in printing. If the logarithm of the luminance channel is taken, it is also necessary to take the inverse logarithm later, in step S1011, detailed below.

An FFT mask is then generated to reduce global contrast and accentuate local contrast (step S1007). The mask, represented by F(x,y) in the equation below, is generated based on the original image data through the following equations:

F(x,y)=(1−1/N)*H(x,y)+1/N,

where N is the enhancement value of the filter, discussed herein, and H(x,y) is given as follows:

H(x,y)=1−(1/(1+[D₀/D(x,y)]²))

where D₀ is the cutoff frequency at a distance D₀ from the origin, discussed herein, and D(x,y) is given as follows:

D(x,y)=[(x−L/2)²+(y−W/2)²]^{1/2}

where L*W is the size of the original V channel.

D₀ and N are both parameters to the mask, and can be adjusted to affect mask properties. Recommended values are D₀=0.25 and N=2.5. Increasing D₀ and N generally lightens an image, so enhancement and cutoff values must be larger for darker images, and smaller for lighter images. The value for N can alternatively be estimated using the amount of space between major peaks in the luminance histogram. For a luminance histogram with a narrow space (a double-peak shape), a larger N is required. For a luminance histogram with a wide gap between peaks (a inverse-bell shape), a smaller N is required. D₀ is the maximum attenuation threshold for values represented in the FFT.

After the mask, F(x,y), is generated, the inverse FFT of the FFT mask is generated (step S1009). The FFT mask of the image, as generated in step S1007, is convoluted with the inverse FFT of the FFT mask, as generated in step S1009 (step S1010). This process allows calculations to be performed in the spatial domain, while maintaining the benefits of a frequency domain image enhancement algorithm.

If the logarithm of the luminance information was taken in step S1006, the inverse logarithm is taken of the manipulated luminance information (step S1011). If optional step S1006 was not performed, the inverse logarithm is not taken in step S1011.

The luminance information is then preferably normalized to encompass a range of 0 to 255 (step S1012). Although this step is optional, normalizing makes the luminance values encompass the entire channel, maximizing the effect of the enhancement. This spatial domain luminance information replaces the original luminance channel of the image (step S1014), and the image is converted from the color space used above, to the original image color space (step S1015). The enhanced image is then output (step S1016).

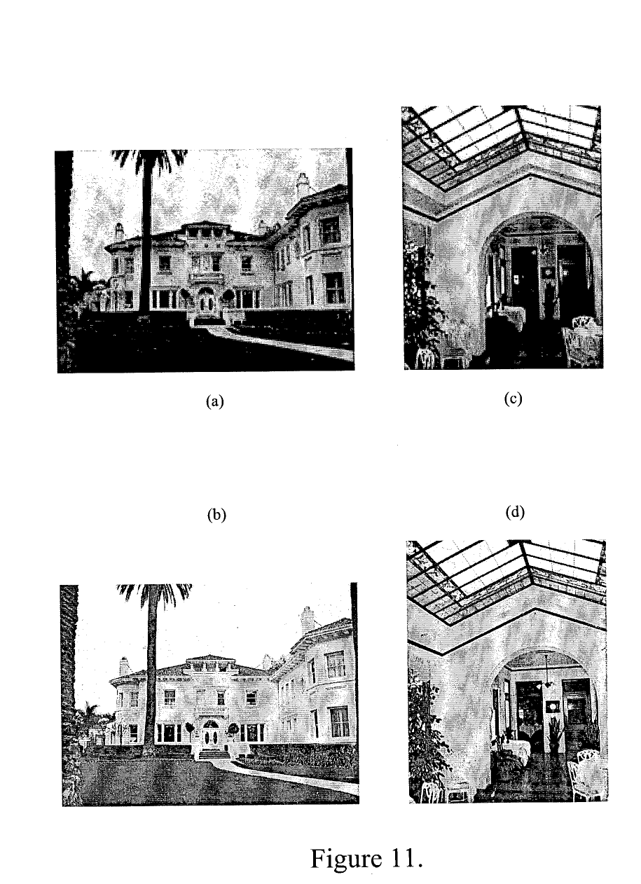

FIGS. 11(a) to 11(d) depict sample images before and after the enhancement described in this invention. FIG. 11(a) shows a low contrast image, and FIG. 11(b) shows the same image after enhancement. Similarly, FIG. 11(c) depicts another low contrast image, and FIG. 11(d) shows the same image subsequent to enhancement.

The invention has been described with particular illustrative embodiments. It is to be understood that the invention is not limited to the above-described embodiments and that various changes and modifications may be made by those of ordinary skill in the art without departing from the spirit and scope of the invention.

What is claimed is:

1. A method for detecting backlit images by analysis of a luminance histogram to determine if the histogram is inverse bell shaped or double-peaked, using the steps of:
smoothing the histogram;
converting the smoothed histogram into a curve function;
counting the number of crossings of the curve function at a baseline; and
designating the image as backlit if the number of crossings is four or more.

2. A method according to claim 1, further comprising the step of:
shifting the histogram vertically along the Y-axis; and
counting the crossings at a baseline, wherein the baseline is the X-axis.

3. A method for enhancing low contrast and backlit images that include luminance information and chroma information in a spatial domain, comprising:
converting luminance information from the spatial domain to the frequency domain;
applying a mask that reduces global contrast and accentuates local contrast, wherein the mask has parameters which can be adjusted to affect mask properties;
inverting the masked luminance information to obtain manipulated luminance information in the spatial domain; and
replacing the original luminance channel with said manipulated luminance information.

4. A method according to claim 3, wherein the chroma information in the enhanced image remains unchanged, further comprising the step of:
normalizing the luminance information in the spatial domain to encompass the range 0 to 255.

5. A method according to claim 4 or 5, further comprising the steps of:
taking the logarithm of the luminance information calculated in the frequency domain; and
taking the inverse logarithm of the inverted, masked luminance information.

6. A method for enhancing low contrast and backlit images that include luminance information and chroma information in a spatial domain, comprising:
generating a Fast Fourier Transform mask of the image that reduces global contrast and accentuates local contrast, wherein the mask has parameters which can be adjusted to affect mask properties
computing the inverse FFT of the FFT mask;
convoluting the FFT mask of the image with the inverse FFT of the FFT mask; and
replacing the original luminance channel with said manipulated luminance information.

7. A method according to claim 6, wherein the chroma information in the enhanced image remains unchanged, further comprising the step of:
normalizing the luminance information to encompass the range 0 to 255.

8. A method according to claim 6 or 7, further comprising the steps of:
taking the logarithm of the luminance information prior to generating the FFT mask of the image; and
taking the inverse logarithm of the luminance information after convoluting the FFT mask of the image with the inverse FFT of the FFT mask.

9. A computer-readable storage medium in which is stored a program for controlling a computer, said program comprising codes for permitting the computer to perform:
a smoothing step, for smoothing the histogram;
a conversion step, for converting the smoothed histogram into a curve function;
a counting step, for counting the number of crossings of the curve function at a baseline; and
a designation step, for designating the image as backlit if the number of crossings is four or more.

10. A computer-readable storage medium in which is stored a program for controlling a computer according to claim 9, said program further comprising codes for permitting the computer to perform:
a shifting step, for shifting the histogram vertically along the Y-axis.

11. A computer-readable storage medium in which is stored a program for controlling a computer, said program comprising codes for permitting the computer to perform:
a conversion step, for converting luminance information from the spatial domain to the frequency domain;
an application step, for applying a mask that reduces global contrast and accentuates local contrast;
an inversion step, for inverting the masked luminance information to obtain manipulated luminance information in the spatial domain; and
a replacement step, for replacing the original luminance channel with said manipulated luminance information.

12. A computer-readable storage medium in which is stored a program for controlling a computer according to claim 11, said program further comprising codes for permitting the computer to perform:
a normalizing step, for normalizing the luminance information in the frequency domain to encompass the range 0 to 255.

13. A computer-readable storage medium in which is stored a program for controlling a computer according to claim 11 or 12, said program further comprising codes for permitting the computer to perform:
a first scaling step, for taking the logarithm of the luminance information calculated in the frequency domain; and
a second scaling step, taking the inverse logarithm of the inverted, masked luminance information.

14. A computer-readable storage medium in which is stored a program for controlling a computer, said program comprising codes for permitting the computer to perform:
a generating step, for generating a Fast Fourier Transform mask of the image that reduces global contrast and accentuates local contrast, wherein the mask has parameters which can be adjusted to affect mask properties
a computing step, for computing the inverse FFT of the FFT mask;
a convoluting step, for convoluting the FFT mask of the image with the inverse FFT of the FFT mask; and
a replacement step, for replacing the original luminance channel with said manipulated luminance information.

15. A computer-readable storage medium in which is stored a program for controlling a computer according to claim 14, said program further comprising codes for permitting the computer to perform:
a normalizing step, for normalizing the luminance information to encompass the range 0 to 255.

16. A computer-readable storage medium in which is stored a program for controlling a computer according to claim 14 or 15, said program further comprising codes for permitting the computer to perform:
a first scaling step, for taking the logarithm of the luminance information prior to generating the FFT mask of the image; and
a second scaling step, for taking the inverse logarithm of the luminance information after convoluting the FFT mask of the image with the inverse FFT of the FFT mask.
